(19) United States
(12) Patent Application Publication
(10) Pub. No.: US 2026/0111908 A1
(43) Pub. Date: Apr. 23, 2026

(54) CARBON OFFSET TRAVEL TRANSACTIONS

(71) Applicant: SERKO LIMITED, Parnell, Auckland (NZ)

(72) Inventors: Robert James SHAW, Mt Roskill, Auckland (NZ); David William GLADSTONE, Howick, Auckland (NZ); Lilly Bridget MANNERS WOOD, Beach Haven, Auckland (NZ)

(21) Appl. No.: 18/703,865

(22) PCT Filed: Oct. 25, 2022
(86) PCT No.: PCT/NZ2022/050129

§ 371 Date: Apr. 23, 2024

(30) Foreign Application Priority Data
Oct. 26, 2021 (NZ) 781651

(51) Int. Cl. G06Q 30/018; G06Q 10/02

(52) U.S. Cl. CPC G06Q 30/018; G06Q 10/02

(57) ABSTRACT

A method of providing a carbon offset to travel taken by a traveller (101) for an organisation (102) and maintaining an audit log of such carbon offsets. Booking the travel via a travel booking service (103), allocating a unique code. Searching the travel booking database (201) after the completion date of at least one facet of the travel, cumulating the carbon offset payment figures for those facets identified as having completed and not yet subject to a carbon offset request. Completed segments can be detected by geo-location or by searching the travel booking database 24 hours after the expected completion date. Presenting a carbon offset request for those completed facets. Receiving at the booking provider from the carbon offset provider (111) confirmation of the acceptance of the request identified by the unique code. Completing the transaction. Storing each transaction in an audit log. Closing the travel as completed after the expiration date of the travel and the cumulation of all confirmations of carbon offset payment figures for all facets of the trip.

### FIELD OF THE INVENTION

The invention relates to the management of carbon offset payments in relation to travel related booking

### Definitions

“Booked service” is a future travel service that has been booked e.g., a flight, hotel stay, rental car reservation.

“Carbon Emission” is the CO₂ released as the result of some activity.

“Carbon Emission Estimate” is an estimate of the carbon emission produced by an activity in this specification by the travel related emissions made by a travel/accommodation/services provider, e.g., in the case of a flight it is the amount of carbon emissions that will be generated by a qualifying travel service as estimated by the related organisation's carbon offset provider based on attributes of the travel service (e.g., flight time, airline, aircraft type, cabin class, destination). The methodology for calculating emissions may change over time and may be subject to regional jurisdiction.

“Carbon Offset” is a payment made to a person or organisation which offsets the CO₂ released by a carbon emitting activity by funding an activity which stores CO₂.

“Carbon offset provider” is an organisation providing carbon offset.

“Carbon offset programme” a carbon-negative initiative offered by a carbon offset provider creating carbon credits which can be purchased by organisations to offset their carbon emission estimate. The nature of such projects will vary by provider and the choice of which is used is negotiated between the organisation and the carbon offset provider. The carbon offset programme determines the offset rate.

“Comprise”: It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e., that it will be taken to mean an inclusion of not only the listed components it directly references, but also other non-specified components or elements. This rationale will also be used when the term ‘comprised’ or ‘comprising’ is used in relation to one or more steps in a method or process.

“Offset rate” is the cost to offset a carbon emission unit (e.g., per tonne of CO₂ emitted by a process)

“Offset transaction” is a recorded monetary value paid to a carbon offset provider by a person or organisation to offset their estimated carbon emission in some activity.

“Organisational carbon emission estimate” the total amount of carbon emissions generated as a result of organisational service use, as estimated by the organisation's carbon offset provider.

“Organisational service use” the collection of all qualifying used services associated with a single organisation over a specific period of time. Initially flights and extending to other travel modes in future.

“PNR” is the abbreviation for a Passenger Name Record.

“Tenant Database” an organisation's record of travel bookings accessible to the travel booking system, these can be separate databases or more likely separate partitions, virtual partitions, segments or groupings within a database, with each partition denoting an organisation's travel bookings and/or travel requirements.

“Travel Booking Service” includes all booking services including Zeno, Amadeus, Sabre and others.

“TMC” is the abbreviation for a Travel Management Company

“Travel mode” a type of travel service including move (by land, sea, air or space) including but not limited to flight, stay, rental car, transfer, travel services for Move (e.g., Rail, rail transfers (e.g. Stanstead or Heathrow Express), Car share, alternate transport forms (Lime bikes, scooters etc), Eat (e.g. restaurant bookings, food to order delivery services etc), Play (events, activities, tours, shows, concerts, theatre etc), Work (Marketplace integrations with partners, ERP providers, Payment providers, Insurance cover, Business services e.g. Servcorp, Regus, WeWork etc), Rest (Wellbeing services, Nail/Feet specialists, spas, massage, fitness studios, hairdressers etc).

“Travel service” a specific element of a trip such as a flight, hotel stay, rental car reservation. Each travel service has an associated travel mode.

“Used service” a travel service that has been consumed by a traveller e.g., a flight that has been flown, a rental car that was used, a hotel stay that wasn't a no-show.

Zeno is a trademark of the Applicant Serko Limited and is used to denote its booking system.

### BACKGROUND ART

There is a problem with existing methods of carbon offset travel transactions.

It is known to book travel via web-based or other services, typically booking flights, car rental, house rental or hotel bookings, restaurants and taxis.

All of these services involve some aspect in which CO₂ is generated, and as such the service may be subject to a carbon offset tax or obligation. Many of these services provide an estimate of the amount of CO₂ created by any activity booked through them and some of them include such a charge in their costings either as a charge or as a voluntary contribution, largely depending on travel provider origin countries.

The present application relates to the interaction between a service carrying out the travel booking and a separate service providing carbon offsets for sale. Typically, where airline travel is involved, the carrier will include or offer to include some form of carbon offset charge in the ticket price—but that charge should only be turned into a carbon offset when the ticket has actually been expended; that is, the flight and the booked passenger have reached the destination, since the CO₂ is not created until the trip is actually made.

Similarly, a temporary hotel room booking should not have the carbon offset charged until the person booked into the hotel has arrived, taken up residence and then finally left.

There is also the added complication of events occurring in different time zones.

Where such travel relates to an organisation paying carbon travel estimates it is booked through a Travel Management Company (TMC) and the travel excluding any carbon emission estimate should have been pre-paid to the travel provider some time before the date of travel unless the organisation has opted otherwise. An obligation still exists for the TMC to pay the carbon offset estimate once the travel is complete and to on charge this to the organisation, or to arrange for the organisation to pay the required offset fees. But there is no easy way of knowing if a traveller was on the booked flight as airlines do not release information on who has travelled (for security and privacy reasons). Hence it is difficult to determine if the travel service has been used and if there is an obligation to pay a carbon offset provider. On average from 10% to 20% of organisational travel is cancelled or changed for one reason or another. During outbreaks of the Covid epidemic organisational flight cancellations increased to 40% to 50% on average.

It should be remembered that carbon offset payments are not paid to a travel provider, rather they are offset transactions with a body which has contracted to support or carry out some activity which reduces the amount of CO₂ in the atmosphere. This activity may perhaps relate to planting more trees, increasing the plankton in the sea, augmenting available water in a drying area to increase vegetation and other similar methods of reducing atmospheric warming.

Different carbon offset providers may have significantly different data requirements for used services so there is a problem in how to aggregate the information for an organisation (having multiple travellers) and to transmit the necessary information to different carbon offset providers.

### PRIOR REFERENCES

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications may be referred to herein; this reference does not constitute an admission that any of these documents form part of the common general knowledge in the art, in New Zealand or in any other country.

### Problem to Be Solved

How can a travel booking service determine when a trip has been completed by a passenger for an organisation when airlines do not release information on who has travelled (for security and privacy reasons) and then cause an account to be issued by a carbon offset provider to the passenger's organisation for all or part of the carbon offset payment that the organisation has agreed to pay.

To complicate the matter, the payments may be made in partial payments at any stage of the travel for those stages so far completed and each airline on a codeshare ticket will have its own data and separate PNRs. For security and data protection reasons airlines will not allow the travel booking service to check on the identity of passengers on a flight. Also, the travel booking service has no apparent interface into the traveller's organisation and cannot tell when the traveller actually completed part or all of the trip.

### OBJECT OF THE INVENTION

It is an object of the invention to provide carbon offset travel transactions that ameliorate some of the disadvantages and limitations of the known art or at least provide the public with a useful choice.

### SUMMARY OF THE INVENTION

This specification proposes payment monitoring methods for use in tracking the state of travel bookings and paying the carbon offset when it is due on behalf of the traveller or traveller's organisation.

In one aspect the invention provides a method of providing a carbon offset to travel taken by a traveller for an organisation comprising:
booking travel for a traveller through a travel booking service, that travel booking being identifiable by a unique code, and a scheduled time/date,
associating a carbon offset payment figure with each facet of the travel to be taken;
after the completion of the scheduled time/date of at least one facet of the travel;
cumulating the carbon offset payment figures for those facets identified as having completed and not yet subject to a carbon offset request,
presenting a carbon offset request for those facets and each containing the unique code to a carbon offset provider on behalf of the traveller organisation;
receiving at the travel booking service from the carbon offset provider confirmation of the acceptance of the request with the unique code,
receiving at the traveller organisation a request for a carbon offset relating to the travel booking with the unique code,
carrying out, by or on behalf of the traveller organisation, an offset transaction with the carbon offset provider relating to the unique code, for the amount of the carbon offset request,
following the expiration date of the travel and the cumulation of all confirmations of carbon offset payment figures for all facets:
closing the travel as completed.

Preferably the travel booking system maintains separate records of travel bookings for each organisation, these can be separate databases or more likely separate partitions within a database, with each partition denoting an organization's travel bookings and/or travel requirements.

Preferably the relevant database or databases is searched for non-cancelled travel at least 12 hours after the scheduled time/date of the travel service.

Preferably the relevant database or databases is searched for non-cancelled travel at about 24 hours after the scheduled time/date of the travel service.

Preferably the relevant database or databases is searched for non-cancelled travel at any time between 24-48 hours after the scheduled time/date of the travel service.

Optionally a copy of the relevant database or databases can be made at least 12 hours after the scheduled time/date of the travel service, and the copied database or databases is searched for non-cancelled travel.

Preferably each segment of a trip is recorded as a separate travel service each with its own unique code.

Preferably each unique code includes information on the traveller ID and the organisation ID to which the traveller belongs.

Preferably the unique code includes a PNR identifying that traveller.

In another aspect the invention provides a method of providing a carbon offset to travel taken by a traveller for an organisation comprising:
booking travel for a traveller through a travel booking service, that travel booking being identifiable by a unique code,
associating a carbon offset payment estimate with each facet of the travel to be taken;
after the completion date of at least one facet of the travel;
cumulating the carbon offset payment estimates for those facets identified as having completed and not yet subject to a carbon offset request,
presenting a carbon offset request for those facets and containing the unique code to a carbon offset provider on behalf of the traveller organisation;
receiving at the travel booking service from the carbon offset provider confirmation of the acceptance of the request with the unique code,
receiving at the traveller organisation a request for a carbon offset relating to the travel booking with the unique code,
carrying out, by the traveller organisation, an offset transaction with the carbon offset provider relating to the unique code, for the amount of the carbon offset request,
following the expiration date of the travel and the cumulation of all confirmations of carbon offset payment figures for all facets:
closing the travel as completed.

Preferably the unique code includes an identifier of the traveller.

Preferably the traveller identifier is the traveller Passenger Name Record (PNR).

Preferably the carbon offset charges are presented to the traveller organisation by the carbon offset provider.

Preferably confirmation of the travel by the traveller is made prior to presenting the carbon offset request to the carbon offset provider.

In a further aspect the invention provides a method of providing a carbon offset to travel taken by a traveller for an organisation comprising: booking travel for a traveller through a travel booking service, that travel booking being identifiable by a unique code, and requiring the traveller to register their geo-location mobile device (preferably their phone) with the travel booking system, associating a carbon offset payment figure with each facet of the travel to be taken; after the completion date of at least one facet of the travel; checking the geo-location record of the traveller's mobile device with one or more designated way-points of the traveller's itinerary, cumulating the carbon offset payment figures for those facets matching the waypoints as having completed and not yet subject to a carbon offset request, presenting a carbon offset request for those facets and containing the unique code to a carbon offset provider on behalf of the traveller organisation; receiving at the booking provider from the carbon offset provider confirmation of the acceptance of the request with the unique code, receiving at the traveller organisation a request for a carbon offset relating to the travel booking with the unique code, carrying out, by the traveller organisation, an offset transaction with the carbon offset provider relating to the unique code, for the amount of the carbon offset request, following the expiration date of the travel and the cumulation of all confirmations of carbon offset payment figures for all facets: closing the travel as completed.

Preferably the unique code includes an identifier of the traveller.

Preferably the traveller identifier is the traveller Passenger Name Record (PNR). Usually this refers to an individual traveller, but it can also be used to identify a group of travellers all with the same itinerary.

Preferably the carbon offset charges are presented to the traveller organisation by the carbon offset provider.

Optionally confirmation of the travel by the traveller is made prior to presenting the carbon offset request to the carbon offset provider.

### BRIEF DESCRIPTION OF THE DRAWINGS

FIG. 1 shows a diagram of the information passed in creating a travel booking which will attract the requirement for a carbon offset and in the charging of the carbon offset.

FIG. 2 shows the interactions which result in the payment of a carbon offset to a carbon offset provider

FIG. 3 is a schematic view of the interaction between the Zeno booking platform and a Carbon Offset Provider.

FIG. 4 shows a number of tenant databases and the Function App which searches for “non-cancelled travel events” in the past.

FIG. 5 shows some of the problems with the interaction between different components of the system.

FIG. 6 shows a preferred booking system.

### DESCRIPTION OF THE PREFERRED EMBODIMENT(S)

The following description will describe the invention in relation to preferred embodiments of the invention, namely a carbon offset travel transactions The invention is in no way limited to these preferred embodiments as they are purely to exemplify the invention only and that possible variations and modifications would be readily apparent without departing from the scope of the invention.

### Example 1

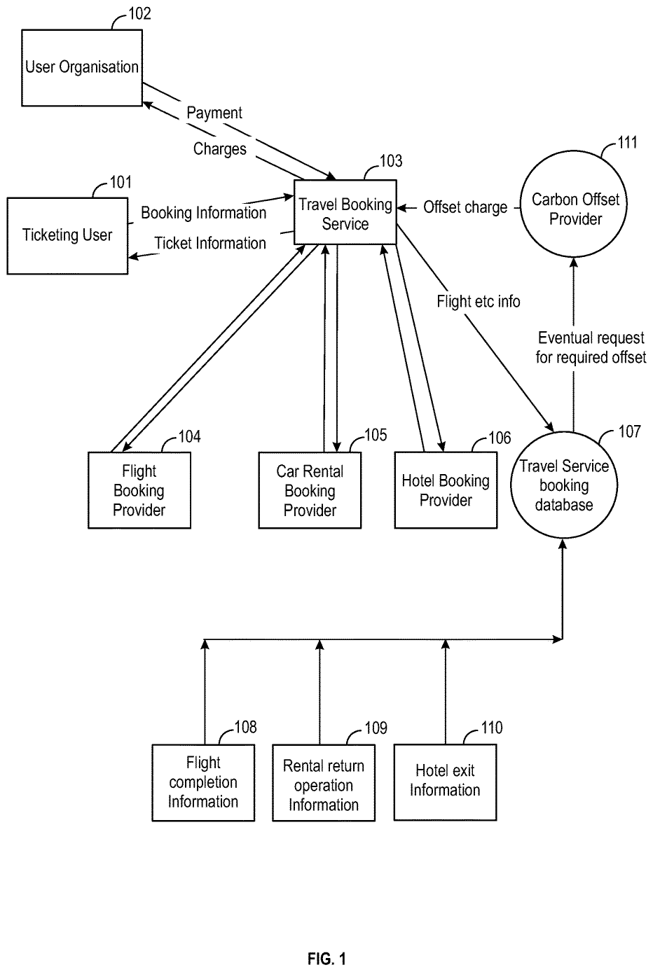

FIG. 1 shows the process of booking travel through a travel booking service. A traveller at 101 of user organisation 102, through a website or otherwise, (directly or indirectly often via TMC) contacts a travel booking service 103 with details of the required travel. The booking service retrieves data from the appropriate booking provider, such as a flight booking provider at 104, a vehicle rental service 105 or a hotel or motel booking provider at 106. The traveller may be a member of an organisation serviced by the travel booking service with the travel booked against the organisation.

The traveller 101 selects the travel modes required and identifies the flights/car hire/accommodation required. The travel booking service 103 identifies travel services which will meet the requirements and tentatively books them through a flight booking provider 104, car rental booking provider 105 or a hotel booking provider 106. At the same time the fares for these requirements are totalled together with the traveller's contributions towards carbon offset as either agreed by the organisation 102 the traveller 101 belongs to or as suggested by the traveller 101 or travel providers 104, 105, 106 to the travel booking service 103.

This results in a payment by the traveller's user organisation 102 to the travel booking service 103 for the total fare/hire/accommodation expenses plus a commitment to a carbon offset contribution and the issuing of tickets or confirmations to the traveller 101. The bookings can retain an indication that the carbon offset portion of the expenses has not yet been expended, since the travel has not been completed. This allows repayment of the fares to the traveller and the rescinding of a relevant part of the pending carbon offset should there be any reason for cancellation of the travel or any part of it.

Several problems arise in connection with the accounting for and auditing of the carbon offset portion of the travel payment, depending on who is responsible for tracking these payments.

Firstly, the carbon offset portion of any fee cannot be expended until the trip/hire/accommodation has been completed. Until this occurs the carbon offset contribution may be either held by the travel booking service as a pending expense to the traveller's organisation until any trip sector is completed or the traveller's organisation is charged the carbon offset contribution initially or the carbon offset provider charges the traveller or traveller's organisation directly.

Complications arise, since if a traveller is travelling to a destination on two flights, then each flight must be confirmed as having taken place before the whole carbon offset can be confirmed with the carbon offset provider 111. Similarly, it is possible that the travel may never take place because of some travel problem and equally it is possible that the traveller has altered the travel arrangements, possibly by direct contact with the travel provider, without altering the travel details with the travel booking service. Either will result in a trip which may not easily traceable to completion by the travel booking service 103 and either will give an incorrect result for the carbon offset charge.

Where the travel is cancelled the traveller or traveller organisation would normally advise the travel booking service seeking a refund, allowing the trip costs to be refunded and any carbon offset already paid to be refunded by the payer.

Where the travel has been altered by other than the travel booking service 103, and hence is now traceable only with difficulty, the travel booking service has to assume that the travel did indeed take place on the date specified, and that an offset request should be presented to the carbon offset provider 111.

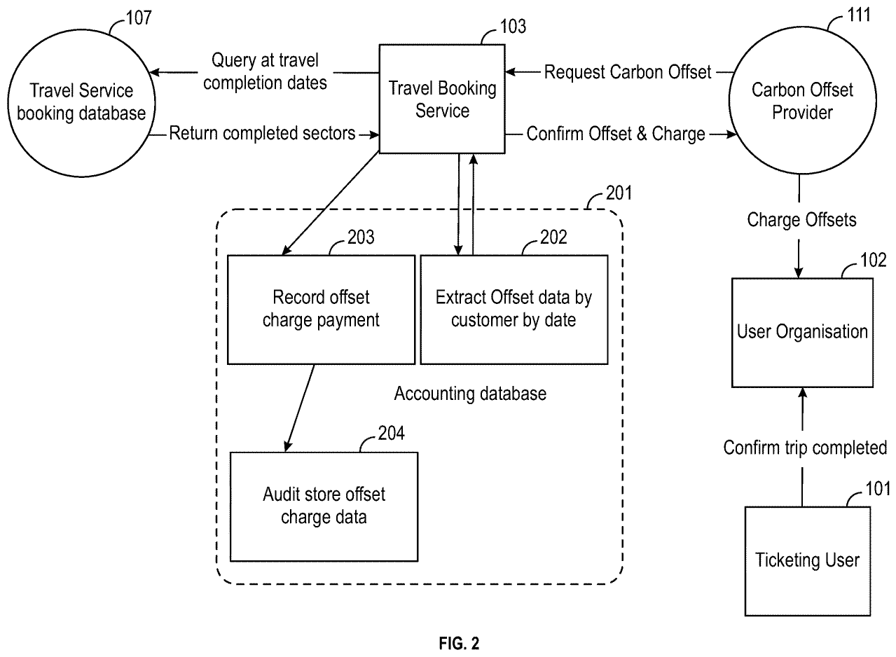

FIG. 2 shows the flow where the normal path is followed and where the Travel Booking Service 103 at the travel completion date queries the Travel Service booking database 107 for trips which should have completed by that date. For some types of travel a check can be made if considered necessary, for instance a flight query as to the landing time of a traveller's flight could be made to check for unexpected flight cancellations or delays, however this requires the assumption that the traveller was on the delayed flight or a replacement flight.

Given that payment of a carbon offset does not currently need to be timely, the preferred solution is to delay the processing of the carbon offset payment until it is reasonably certain that the traveller has not advised the booking service 103 of any change or cancellation of any phase of the travel. This may push the processing step to occur 24 to 48 hours after the predicted traveller arrival time for a flight and 24 to 48 hours after the traveller should have left a hotel or finished a car rental. This allows the system to accommodate delayed flights or allow sufficient time to allow a traveller to record the cancellation or change of a booking via TMC and for that change to filter through to the inventive system checking for possible carbon offset payments.

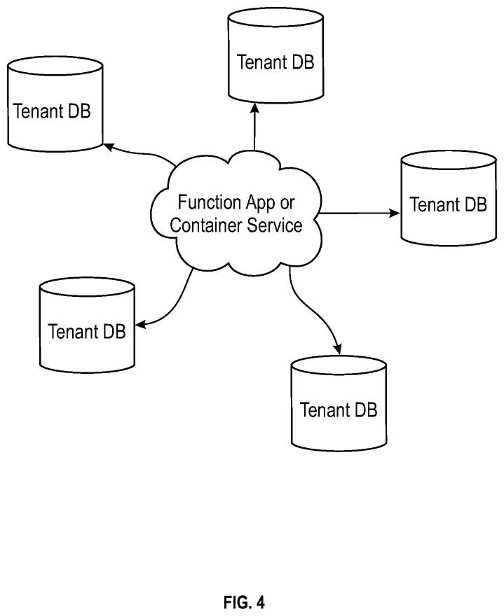

At this time the booking database is queried for trip data, the accounting database 201 queried for the carbon offset type and value for the trip concerned or for the part of the trip so far completed and not yet with a carbon offset completed. Searching the database creates difficulties as it may interfere with or slow down ongoing bookings. Preferably such searches are carried out at off-peak times in a particular time zone, or alternatively a copy of the database is made, and the non-live copy is used for searches. The latter solution requires repeated copies at intervals matching the required delay time. As will be seen from FIG. 4 each organisation will have its own database within the booking service so that travellers belonging to that organisation can readily be identified and their travel bookings checked to see if they have been cancelled or modified.

The carbon offset request is then presented to carbon offset provider 111 for payment by the travel request originator—here either the traveller 101 or the traveller's organisation 102. If acceptance of the carbon offset request is confirmed by the carbon offset provider (that is, no facet of the trip is rejected) it is recorded in the accounting database at 203 and stored for audit purposes at 204. Where part or all of the carbon offset request is denied by the carbon offset provider 111 a record must be kept by the travel booking service 103.

Difficulties arise in tracking the booked travel through the entities concerned—the traveller's organisation 102 may have an internal staff tracking reference for the traveller 101 and possibly a reference for the trip, the traveller 101 will probably have a unique airline PNR (Passenger Name Record), the trip will have a reference with the travel booking service and that reference will point to the traveller's organisation 102, the carbon offset provider will have customer records for the travel booking service 103 and the traveller's organisation 102 (passed by the travel booking service 103).

Preferably a key for this travel relates to the traveller 101 PNR and a unique trip reference generated by the travel booking service 103 and disseminated to the traveller's organisation 102 and the carbon offset provider 111.

### Example 2

At its core, the design revolves around the process identifying an organisation's used services, forwarding relevant details to a carbon offset provider to create offset transactions, and keep an audit record of this process. The booking service described herein is Zeno (trademark of Serko Ltd), but this invention is equally applicable to other booking services.

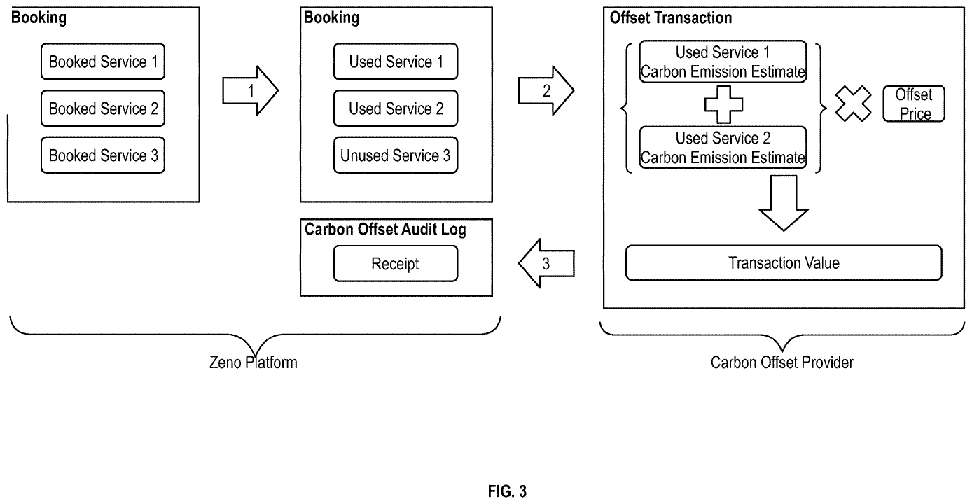

FIG. 3 shows the relationship between the invention and the Carbon offset provider. Once the system has identified “non-cancelled” travel events in the past it can pass the information to a Carbon offset provider, which can record the transaction and issue an invoice which can then be recorded in the Carbon Offset log to ensure that the “used services” are not identified in a future search.

At a very high level, starting with a booking being made for several travel services e.g., two flights and a hotel stay:

At some point in the future, some of the booked services are used (e.g., the flights are flown). Some services may not be used (e.g., a no-show for a hotel booking).

Details of each used service are passed to a carbon offset provider which generates a transaction record in their system. The organisation will be invoiced for this amount at some later point; this is the responsibility of the carbon offset provider.

The carbon offset provider then provides acknowledgement of the transaction creation-a receipt—which is associated with the booking for audit purposes.

The key steps to the process are:
Identify used services to offset
Identify carbon offset provider and programme
Pass used service data to carbon offset provider to create an offset transaction Record transaction details in an audit log

The following sections will describe these steps in more detail.

### Identify Used Services to Offset

There are decisions to be made identifying determining what to offset:

How should “used services” be grouped together into transactions?

What used services should be offset?

### Grouping Used Services

A simplifying assumption is that the booking that ‘contains’ the travel services will be the grouping entity for the offset transactions. They can be grouped by relevant Tenant ID—i.e., all services booked and recorded in a Tenant Database (see FIG. 4).

It is assumed that the booking system will manage large numbers of bookings for different organisations and maintain these records in separate “Organisation/Corporate/Tenant Databases” for security and privacy reasons. Once all the booked services on a booking are fully in the past (e.g., return flight has landed) they can be inspected and considered for offset or not.

Preferably the Zeno booking identifier and PNR reference (where available) should be used as an external identifier in the offset transaction.

### Required Design Elements:

A mechanism to retrieve a PNR reference number for a booking.

A unique identifier for a Zeno booking across all instances of Zeno.

### Identifying Eligible Used Services

There are two elements to consider:

What constitutes a used service?

What types of used service are eligible for inclusion in a carbon offset transaction?

In an ideal world, for each type of service referenced by a booking record, there would be some way to query its status with the provider of the service and use this information to decide the “used” status of a past service. In reality, we can only rely on the information that Zeno holds about the booking; if a booking is changed offline by a TMC and the updated booking is not updated into Zeno then offsetting may be incorrect.

Therefore, we make the following simplifying assumptions:

If a customer hasn't cancelled a flight before the first flight departed, the ticket would be forfeit and the associated PNR should be cleaned up by the TMC as a result of the airline updating the status of the ticket and this should be updated back into Zeno.

In the event that Zeno is not updated to reflect a material booking change (such as a cancellation or change of dates) and an offset transaction is created when it shouldn't (or not created when it should), this error can be audited and rectified by using the PNR reference number from the offset provider transaction to trace back to the TMC and Zeno records.

It is OK to introduce latency of up to 24 to 48 hours into the offset transaction generation process following the completion of travel to avoid issues relating to delayed updates and time zone related calculations.

With these assumptions in place, we can assume that a service associate with a specific booking has been “used” when all of the following are true:

All non-cancelled services on the booking have associated dates that are all are in the past.

As for eligibility for offsetting, that is determined by the capabilities of the organisation's configured carbon offset provider. Anything that can potentially be offset by a provider will be considered for inclusion.

### Required Design Elements:

A mechanism to efficiently identify bookings that are “in the past” and have not previously been offset. A mechanism to identify non-cancelled services on a booking.

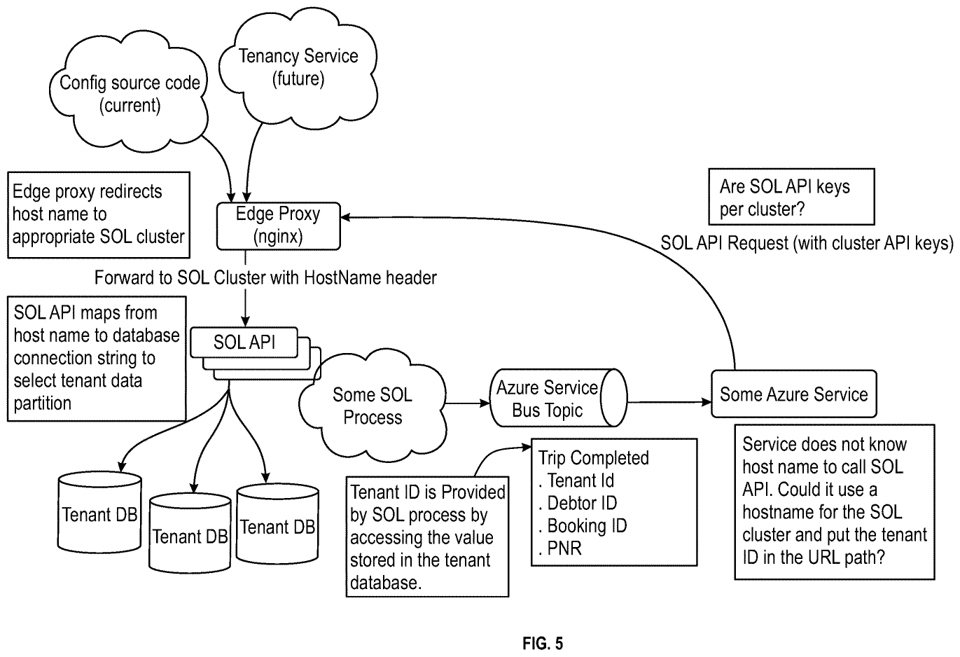

FIG. 5 identifies some of the problems in linking the services using SOL API (an internal component of Zeno) and the need for a unique identifier for each service transaction recorded in the booking system.

### Identify Carbon Offset Provider and Programme

Ideally the travel booker would have identified the carbon offset programme to which they would like the used services attributed when booking their travel. Regardless, of whether or not this has happened, there are additional checks that need to be made at this point:

Is the organisation still enrolled in any carbon offset programme?

If a programme was selected during booking, does that programme still exist?

If no programme was selected during booking, or the selected programme no longer exists, which programme should be used?

### Required Design Elements:

A mechanism to determine the default carbon offset provider and programme by organisation.

A mechanism to determine the carbon offset programme and provider preference by booking.

### Pass Used Service Data to Carbon Offset Provider

Assuming that a carbon offset provider and programme have been identified for a booking, the next step is to pass details of the used services and the booking references to the carbon offset provider to generate a transaction.

It is the responsibility of the carbon offset provider to decide what it is capable of offsetting. This approach will enhance our ability to drop in alternate carbon offset providers in future without having to modify the core platform behaviours.

An important consideration for supporting multiple carbon offset providers is that they each may have significantly different data requirements for used services. Defining a one-size-fits all data model for a provider API contract is likely to end up having to contain all data elements for all types of travel mode services (flights, hotels, rental cars etc) because constantly updating a provider API contract will become very difficult to manage. An alternative is to have a simple contract and have the offset provider “adapter” request the data from secure, public Zeno platform APIs.

### Required Design Elements:

A well-defined contract with an offset provider for requesting a carbon offset transaction for one or more used services.

An extensible mechanism for passing used service data between the Zeno Platform and the carbon offset provider to facilitate offsetting of different types of travel mode services (e.g., flights, rental cars, hotels).

A mechanism to prevent used services from being offset more than once.

An audit mechanism to record that an eligible booking has been submitted for offsetting.

### Record Transaction Details in an Audit Log

Once a transaction has been created (or it was determined that no offset transaction was required) then the result, when it is received, must be recorded against the corresponding booking.

### Required Design Elements:

A mechanism to detect when an offset transaction request has completed or failed.

An audit mechanism to record the outcome of requesting a carbon offset transaction to be created against a particular booking.

### Example 3

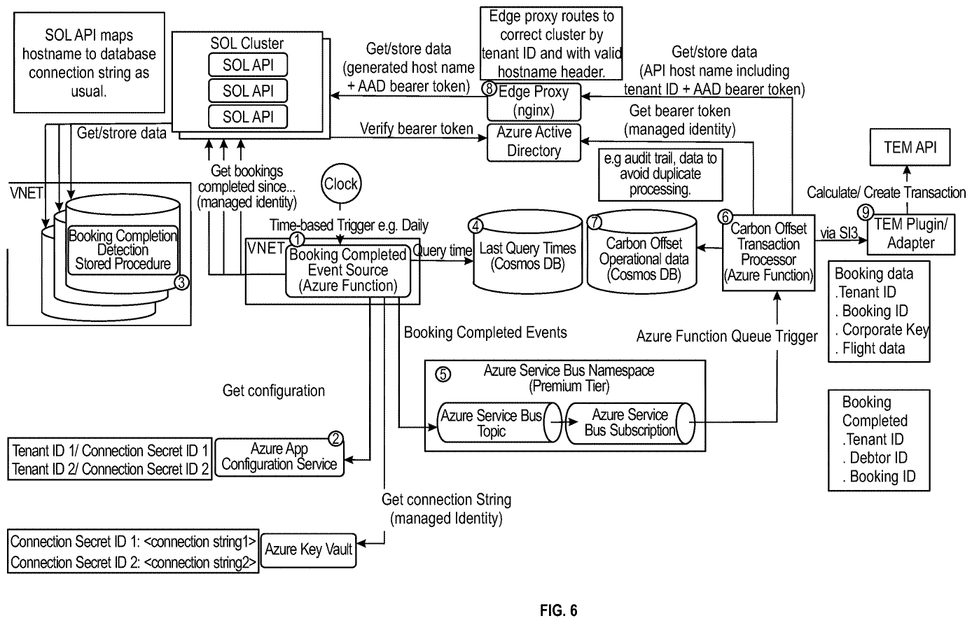

FIG. 6 shows a preferred implementation and how this invention can be implemented using the applicant's booking system known as the Zeno booking system (Zeno is one of the applicant's trademarks). Components labelled 1 to 9 are each described in turn below.

### Booking Completed Event Source

This component is responsible for publishing “booking completed” events to a topic which other components will consume. This part of the solution is not specific to carbon offsetting and could be leveraged by other business processes in future.

This is a C# Azure Function with a timer trigger. It calls a stored procedure in SOL's database via SOL API to receive the identity of bookings that have completed in a specified time range. For each SOL database to be queried, the component must record when it last queried for completed bookings.

An event describing the completed booking is published to an Azure Service Bus topic using NServiceBus. The data elements of the event include:

SOL Tenant ID—identifies the SOL database (see FIG. 4)

Booking ID—identifies a specific booking within a tenant database

A debtor ID derived from the booking ID (identifies the traveller's organisation).

Completed date/time—the time that the booking completed (based on segment info)

The function must have a managed identity which is granted read access to a key vault to obtain SOL database connection strings.

### Azure App Configuration Service

This is an Azure service that provides key/value configuration data to application components. Having a centralised service will allow the list of SOL tenants to be maintained independently as new tenants are onboarded.

Configuration will be readable to all components with a suitable naming convention.

No secrets will be held in this service. Instead, secret IDs for database connection strings can be stored so that the Booking Completed Event Source retrieve the connection strings from the key vault.

### Booking Completion Detection Stored Procedure

This is a new stored procedure in the SOL database that detects bookings that have completed in a specified time window. It returns a row per completed booking with the following information:

Sol tenant ID booking ID

Debtor ID (this can be derived from the Booking ID) Completed date/time

### Last Query Times

A Cosmos DB data store containing details of last query times per SOL tenant database. Whenever a query is successfully handled, the end date of the query range must be persisted.

### Azure Service Bus

A new Azure Service Bus namespace where “Booking” events (and others in future) can be published for subscribers.

### Carbon Offset Transaction Processor

This component responds to a “booking completed” event by determining whether the booking needs to be offset, obtaining the booking details from SOL API, access tokens etc., and invoking the carbon offset provider plugin functionality.

This component is a C# function app using a queue trigger so that it is invoked when a booking has completed. It uses NServiceBus for interfacing with the Azure Service Bus subscription. The function must run with a managed identity in order to interact with SOL API.

The processor is also responsible for recording audit information. Initially, as MVP, this might be a call to SOL API to add info to a booking's audit log; it needs to be determined if such an endpoint exists or needs to be created.

Booking data is to be obtained by leveraging the booking management SOL APIs.

### Carbon Offset Operational Data

This is another Cosmos DB data store holding any persistent data storage requirements of the carbon offset transaction processor. In particular: Audit details.

Records of processed bookings to avoid duplicate transactions being generated.

### Edge Proxy

The nginx proxy configurations are updated with new “tenant ID based” hostnames so that SOL API can be called by tenant id. For example, rather than requesting https://acmetravel.serko.travel/api/ . . . you would request https://acme-001-p-sol.serko. travel/API/ . . . to the same SOL web cluster that would handle acmetravel.serko.travel requests; to SOL API these would appear identical and would function correctly.

The mapping from hostname to database connection string is configured automatically as part of SOL API deployment, so all that needs to happen is for a new, “standardised” hostname to be added to each tenant.

TEM Plugin

This is an existing standalone Serko web service exposing an API which provides carbon emission estimates. TEM is a carbon offset provider.

This component should be modified with a new API endpoint to generate a carbon offset transaction for a specified booking. The details of calculations and transaction creation should be encapsulated within this component rather than being separate operations that are coordinated by a calling client; this allows for future interactions with a variety of carbon offset providers.

Ideally the API would become the standard API for other carbon offset provider plugins to implement. Preferably all the data required for creating the offset transaction is included in the API request payload.

The API request payload includes the following:
TENANT ID
BOOKING ID
CORPORATE ACCESS KEY
FLIGHT DATA

Note that requesting data from an API relies on the booking not changing between a request being sent and the booking detail being retrieved, or on a specific version of a booking being able to be returned. Which is why we prefer to wait 24 hours from the scheduled flight time before querying the Tenant Database to ascertain unchanged bookings.

Preferably the processing time required is managed to minimise peak API loads. And preferably the booking complete event service is deployed in each geographic region in order to access SOL databases for all clients.

### Example 4

In this example the booking system makes use of a traveller's geo-capable mobile device such as a phone to check the traveller's location against defined waypoints on the travel itinerary to check that each segment of the travel has been completed.

This may be used instead of checking if any segment has been cancelled as in the previous examples, or more preferably it can be used in conjunction with the steps of the previous examples.

By linking the travel booking with a unique code (preferably the traveller's PNR) and linking that to the geo location feature of the traveller's mobile device it is possible to obtain early confirmation of the completion of each segment of the travel itinerary. This can also be used in conjunction with land or sea-based travel modes or with the consumption of various services, e.g., accommodation or restaurants or any other services consumed by the traveller, as each has associated geo-location(s).

Preferably the mobile device has a travel app linked to the travel booking system designed to check for each designated waypoint on the travel itinerary and to record the location of the mobile device relative to a waypoint and to record a date/time stamp for that event. Whilst this can be recorded on the mobile device and downloaded later, it is preferable that the mobile device is configured to send an update to the travel booking system when each waypoint is detected.

In most cases this can be achieved by storing the GPS location of each waypoint (either in the travel booking system's server) or more preferably on the traveller's mobile device and comparing the GPS location of the mobile device with the stored GPS locations to determine if the mobile device is near the stored GPS location. How near that needs to be depends on the travel mode. In the case of a large airport with several disparate terminals such as Heathrow—the proximity might need to be within a 10 km radius or larger, whereas if the waypoint is associated with a particular restaurant or hotel the proximity might need to be restricted to a 100 m radius. What is important is that the mobile device can detect if the traveller has completed a travel segment or consumed a designated service.

Once the travel booking system has received confirmation that the geo-location record of the traveller's mobile device corresponds with one or more designated way-points of the traveller's itinerary, it can cumulate the carbon offset payment figures for those facets matching the waypoints as having been completed and not yet subject to a carbon offset request.

It can then present a carbon offset request for those facets and containing the unique code to a carbon offset provider on behalf of the traveller organisation as described above.

### Variations

Instead of accessing the live Tenant records the system can take regular snapshots of the relevant database (say at 24-hour intervals) and then search the off-line copy for any bookings in the required time slot that have not been cancelled and then pass the output to the nominated carbon offset provider.

In the case of geo-location this is preferably achieved by checking GPS co-ordinates. However, in some cases it may be preferable to use a wireless beacon and to detect the wireless signal on the traveller's mobile device.

### Advantages

The invention allows a corporate organization to achieve its objectives of proving carbon offsets for corporate travel whilst minimising the risk of paying the carbon offset provider for trips that have not been used.

### INDUSTRIAL APPLICABILITY

The invention is an enhancement to a travel booking system that allows more accurate records of used flights and other travel services to be made and the information to be sent to nominated carbon offset providers.

1. A method of providing a carbon offset to travel taken by a traveller for an organisation comprising:
booking travel for a traveller through a travel booking service, that travel booking being identifiable by a unique code, and a scheduled time/date,
associating a carbon offset payment figure with each facet of the travel to be taken;
after the completion of the scheduled time/date of at least one facet of the travel;
cumulating the carbon offset payment figures for those facets identified as having completed and not yet subject to a carbon offset request,
presenting a carbon offset request for those facets and each containing the unique code to a carbon offset provider on behalf of the traveller organisation;
receiving at the travel booking service from the carbon offset provider confirmation of the acceptance of the request with the unique code,
receiving at the traveller organisation a request for a carbon offset relating to the travel booking with the unique code,
carrying out, by or on behalf of the traveller organisation, an offset transaction with the carbon offset provider relating to the unique code, for the amount of the carbon offset request,
following the expiration date of the travel and the cumulation of all confirmations of carbon offset payment figures for all facets:
closing the travel as completed.

2. A method of providing a carbon offset to travel taken by a traveller for an organisation as claimed in claim 1 wherein the travel booking system maintains separate records of travel bookings for each organisation.

3. A method of providing a carbon offset to travel taken by a traveller for an organisation as claimed in claim 1 wherein the travel booking system checks the geo-location of a traveller's mobile device against designated waypoints of the traveller's itinerary.

4. A method of providing a carbon offset to travel taken by a traveller for an organisation as claimed in claim 1 wherein the relevant records or database or databases are searched for non-cancelled travel at least 12 hours after the scheduled time/date of the travel service.

5. A method of providing a carbon offset to travel taken by a traveller for an organisation as claimed in claim 1 wherein the relevant records or database or databases are searched for non-cancelled travel at about 24 hours after the scheduled time/date of the travel service.

6. A method of providing a carbon offset to travel taken by a traveller for an organisation as claimed in claim 1 wherein the relevant records or database or databases are searched for non-cancelled travel at any time between 24-48 hours after the scheduled time/date of the travel service.

7. A method of providing a carbon offset to travel taken by a traveller for an organisation as claimed in claim 1 wherein a copy of the relevant records or database or databases is made at least 12 hours after the scheduled time/date of the travel service, and the copied database or databases is searched for non-cancelled travel.

8. A method of providing a carbon offset to travel taken by a traveller for an organisation as claimed in claim 1 wherein each segment of a trip is recorded as a separate travel service each with its own unique code.

9. A method of providing a carbon offset to travel taken by a traveller for an organisation as claimed in claim 1 wherein each unique code includes information on the traveller ID and the organisation ID to which the traveller belongs.

10. A method of providing a carbon offset to travel taken by a traveller for an organisation as claimed in claim 1 wherein the unique code includes a PNR identifying that traveller.
